(19) United States
(12) Patent Application Publication
(10) Pub. No.: US 2001/0037263 A1
(43) Pub. Date: Nov. 1, 2001

(54) Electronic commerce support system

(75) Inventors: Tomoyuki Hirota, Chiba-Shi (JP); Masayuki Yamamoto, Tokyo-To (JP); Hikaru Kagoura, Sagamihara-Shi (JP)

Correspondence Address: RENNER, KENNER, GREIVE, BOBAK, TAYLOR & WEBER, 1610 First National Tower, Akron, OH, 44308-1456, US

(73) Assignee: Victor Company of Japan, Ltd.

(21) Appl. No.: 09/840,845

(22) Filed: Apr. 24, 2001

(30) Foreign Application Priority Data
Apr. 27, 2000 (JP) 2000-127577

(51) Int. Cl. G06F 17/60

(52) U.S. Cl. 705/26

(57) ABSTRACT

An electronic (e-) commerce support system has a Web server to which each retailer makes an access via a terminal of each retailer over a network, thus performing access management for each retailer, a database storing data for each of functions required for e-commerce, and an application server to establish each of the functions by using the stored data, necessary functions among the functions required for e-commerce being offered to each retailer and available through the terminal of each retailer over the network.

### BACKGROUND OF THE INVENTION

The present invention relates to an electronic (e-) commerce support system that allows for the easy creation of online shops by industries or merchandisers wanting to establish e-commerce for the first time. Especially, it relates to an e-commerce support system that enables each industry to establish a wide variety of store styles that reflect its individual needs and circumstances.

Recently, e-commerce has been the focus of much attention, and particularly with regard to transactions dealing directly with the general consumer known as B to C (Business-to-Consumer), “online-shopping” over the Internet is expanding. Further, this online-shopping usually involves the establishment of an independent virtual store by a retailer, who can then open this virtual shop in a virtual mall.

However, many problems arise when the average, smaller retailer attempts to begin e-commerce. For example, when planning to establish a virtual shop, many things such as a shop concept, selection of goods, the amount of goods to stock, the size of the system, order and payment settlement, and means of shipping the products are difficult to establish. Then there is also the need to decide what kind of shop (what kind of homepage) to create.

Furthermore, options such as where to open the shop, for example as a “tenant” in a previously existing mall, and whether to use one's own servers or a rental server must also be considered. In the case where a rental server or one's own servers are used, typically there is a need for the shop design and arrangement to be done by the retailers themselves (or to hire an independent professional), and developing and keeping the system running results in a considerable burden both logistically and financially. While opting to join an already established mall as a “tenant” can lighten this burden, due to the technological systems and the need for solidarity make it difficult to portray the store's flexibility and uniqueness, and thus the retailer is not always guaranteed to be able to open a store that is wholly satisfactory.

Also, regarding the settlement of accounts, postal transfers or bank transfers are the simplest methods, but these include negative factors such as the risk that the money may not have been received at the time of shipping, or other time-lags and accounting problems which may arise. Further, utilizing a C.O.D. (Cash On Delivery) system does away with a risk of not receiving payment, but the expensive surcharges involved must also be considered. Online payment by credit card is the optimal choice, but money must be spent on handling security problems, and system management makes it difficult for private stores to employ this type of payment system.

Also, with regard to management, there is a need for an operations system to keep product sales activities running both smoothly and conservatively.

As above, there are many things that a small retailer must consider when delving into e-commerce. However, there has been a need for the seller themselves to create and manage all of the systems involved with establishing a virtual shop, for example, to provide online-shopping over the Internet. Such retailers that have no knowledge regarding establishing or operating a virtual shop were forced to leave everything into the hands of specialists.

For the average small retailer to start e-commerce, it is necessary to build and maintain the systems related to a virtual shop, in other words web page creation and/or shop construction and management, retaining a server, and many other related and necessary specialty skills, and costs were an obstacle preventing many retailers from participating.

In the case where everything is left up to specialists, considerable costs are involved and it becomes difficult to collect enough profit to simply cover the operating costs. It is also common that the retailers who want to build their own unique virtual shops have difficulty in communicating with the specialists exactly what kind of site they were interested in, thus making in difficult for the specialists to provide adequate service. On top of this, in order to sustain the income of the virtual shop, it is necessary to update the homepage, but when enlisting the help of specialists, problems such as time delays and difficulty in the updates make it difficult for the site to completely reflect the wishes of the retailer.

### SUMMARY OF THE INVENTION

A purpose of the present invention is to provide an e-commerce supporting system that offers several functions for retailers over the Internet to create and run virtual shops in online-shopping system, the functions being selectively offered to the retailers for entering into e-commerce easily.

The present invention provides an electronic (e-) commerce support system including: a Web server to which each retailer makes an access via a terminal of each retailer over a network, thus performing access management for each retailer; a database storing data for each of functions required for e-commerce; and an application server to establish each of the functions by using the stored data, necessary functions among the functions required for e-commerce being offered to each retailer and available through the terminal of each retailer over a network.

### BRIEF DESCRIPTION OF DRAWINGS

FIG. 1 shows a block diagram of an e-commerce (online-shopping) system;

FIG. 2 illustrates a flow chart for explaining a flow of e-commerce shown in FIG. 1;

FIG. 3 shows a block diagram of a preferred embodiment of an e-commerce support system according to the present invention;

FIG. 4 illustrates several template windows fore-commerce support system according to the present invention;

FIGS. 5A to 5F are enlarged views of template windows 301 to 306, respectively, shown in FIG. 4;

FIG. 6 illustrates several windows for e-commerce support system according to the present invention;

FIGS. 7A to 7E are enlarged views of windows 201 to 206, respectively, shown in FIG. 6;

FIG. 8 illustrates an e-commerce system aided by the e-commerce support system according to the present invention for authenticating customers; and

FIG. 9 illustrates several sample e-commerce systems aided by the e-commerce support system according to the present invention.

### DETAILED DESCRIPTION OF PREFERRED EMBODIMENTS

An electronic (e-) commerce support system according to the present invention does not merely provide time-based rental application software but employs an application service provider (ASP) to put several e-commerce operations into modules and provides the modules over the Internet in good cooperation with retailer's system under retailer's requirements, thus achieving creation, maintenance and management of virtual shops, which meet each retailer's requirements.

The ASP offers everybody with several kinds of rental application operation software (programs) stored in a large-scale computer for a certain term over the Internet. Users can use these software at cheaper prices compared to buying them, and requires no hardware maintenance and no manual software upgrade.

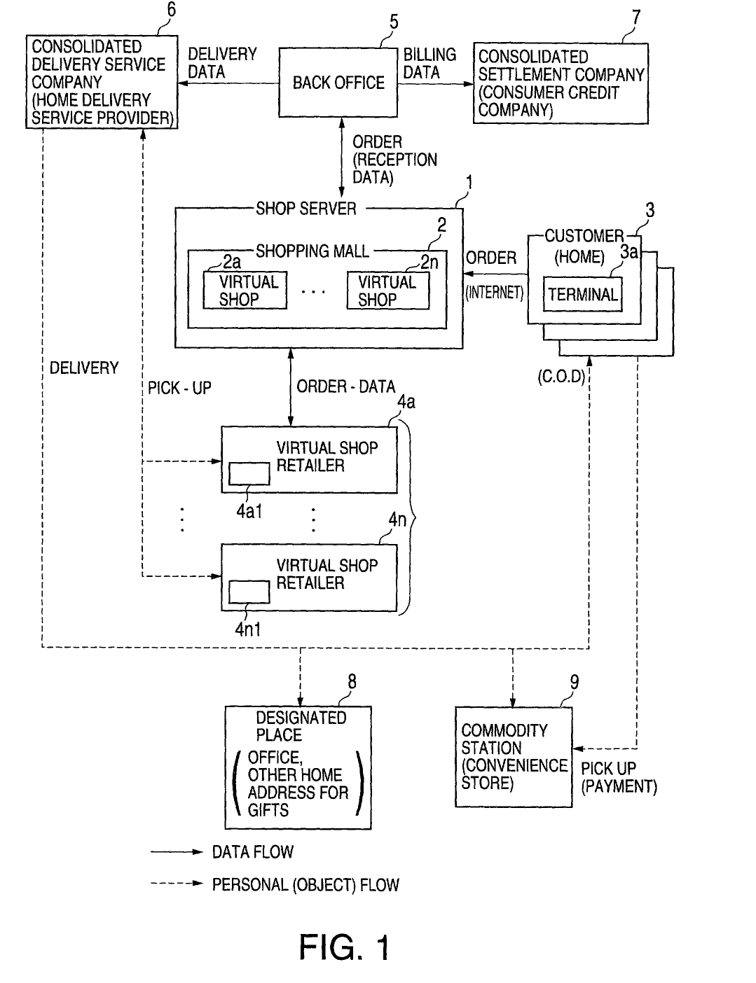

Disclosed first with reference to FIG. 1 is a virtual shop for online-shopping over the Internet.

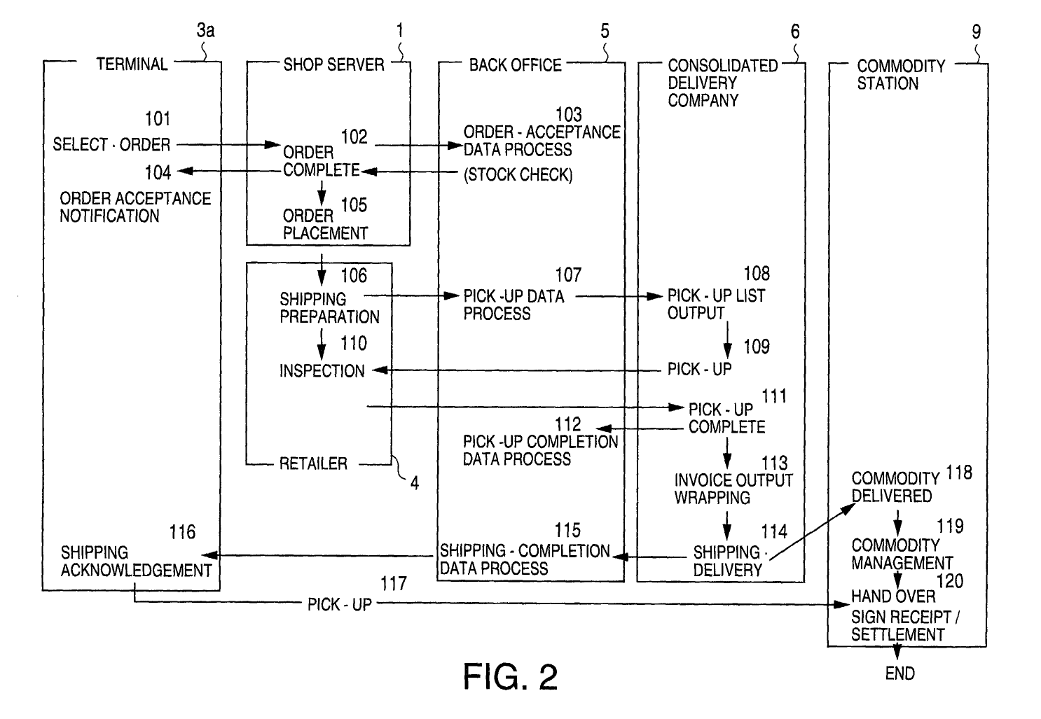

FIG. 1 illustrates a general online-shopping system including virtual shops, through which a customer can designate his or her address, place of residence or the nearest commodity station, such as a convenience store the customer has already designated, as a place to which a commodity is to be delivered when placing an order through personal computer communications, etc. FIG. 2 illustrates a flow chart to explain the process of this online-shopping system.

In FIG. 1, a shop server 1 has been constructed by an online-shopping service provider. Provided on the shop server 1 is a shopping mall 2 including virtual shops 2a to 2n. The shopping mall 2 and the virtual shops 2a to 2n have been virtually created on a large-scale computer with programs running thereon and peripheral apparatuses, such as an external storage apparatus (not shown).

A customer 3 has a terminal 3a that is connectable to the Internet. When placing an order, the terminal 3a is connected to the shopping mall 2 on the shop server 1 over the Internet for selection of a commodity from among the virtual shops 2a to 2n. The terminal 3a is made up of hardware, such as a personal computer or a game-dedicated device, and programs running on the hardware.

The terminal 3a is usually set at the customer's place of residence. However, any terminal, such as a mobile terminal and a mobile phone that are connectable to the Internet, can be used as the terminal 3a. There is only one customer 3 (one terminal 3a) shown in FIG. 1 for brevity. However, there may actually be many customers approved as the members of the online-shopping system.

Virtual shops retailers (called retailers hereinafter) 4ato 4n are the owners of the virtual shops 2a to 2n, respectively, on the shop server 1. The retailers 4a to 4n are provided with virtual-shop terminals 4a1 to 4a1, respectively. Under contract with the online-shopping service provider, the retailers 4a to 4n own the virtual shops 2a to 2n, respectively, on commission to the provider.

Data on the virtual shops 2a to 2n may be stored on the virtual-shop terminals 4a1 to 4n1 of the retailers 4a to 4n, respectively, or on the shop server 1, depending on each retailer. The retailers 4a to 4n own commodities that are for sale at the virtual shops 2a to 2n, respectively.

A back office 5 is a server connected to the shop server 1 for several types of internal data processing. The back office 5 sends delivery data and billing data to a consolidated delivery service company (home delivery service provider) 6 and a consolidated settlement company 7, respectively.

The delivery service company 6 is a home delivery service provider having a commodity center for delivery management. Based on the delivery data sent from the back office 5, the delivery service company 6 picks up a commodity for which an order has been placed from one of the retailers 4a to 4n and delivers it to a designated place.

The consolidated settlement company 7, a consumer credit company, for example, performs a settlement process based on the billing data sent from the back office 5. However, when the customer 3 wants to make payment by funds transfer or C.O.D. (cash on delivery), etc., instead of credit card, the consolidated settlement company 7 sends the billing data to the delivery service company 6 that will perform a billing process.

A commodity station 9 has a contract with the online-shopping service provider, as one of the places to which the consolidated delivery service company 6 delivers a commodity when designated by the customer 3 for temporarily keeping of the commodity. The commodity station 9, such as a convenience store, has been designated and registered among many commodity stations by the customer 3 before or when placing an order, for the nearest location from customer's home or office.

Before or on initial order-placement, the customer 3 applies for membership of the online-shopping system with registration of data on settlement, place of residence, phone number, e-mail address, etc., and also customer identification data. In reply to the registration, the online-shopping service provider sends an ID card storing the customer identification data to the customer 3 by mail. The ID card will be used to identify the customer 3 as a registered member of the online-shopping system. However, the customer identification data may be sent by e-mail to the customer 3 without sending the ID card.

Disclosed next with reference to FIG. 2 is a flow of purchase.

The customer 3 makes an access to the shop server 1 over the Internet via the terminal 3a to select commodities sold in the virtual shops in the shopping mall 2 and places an order (step 101). The customer 3 transmits, as order-placement data, the customer identification data, commodity identification data, data on the number of commodity and data on the place to which the commodity is to be delivered, at least to the shop server 1. As the place to which the commodity is to be delivered, the customer 3 designates one place from among the place of residence, designated place 8, such as someone's home to which the commodity will be sent as a gift or an office the customer 3 have been working for, or the commodity station 9. When designating the place 8, the customer 3 transmits the address and the phone number of the place 8, etc., as a part of the delivery data to the shop server 1. On the other hand, when designating the commodity station 9, the customer 3 selects at least one commodity station 9 (such as a convenience store that opens long hours) most convenient to the customer because it is closest to the customer's home or office from the list of commodity stations transmitted from the shop server 1 on or before the order-placement, and further designates one of the selected stations as the place to deliver.

The shopping server 1 checks whether the order data sent from the terminal 3a is complete (step 102), and if so, the server 1 transmits the order data to the back office as order acceptance data. The back office 5 performs order-acceptance data process such as authenticating the customer 3 and confirming how to charge the customer 3 for the ordered commodity. The back office 5 transmits data on whether there is a stock of the ordered commodity to deliver, etc., to the shop server 1 (step 103). The shop server 1 notifies the customer 3 of the order acceptance on the order confirmation window on the terminal 3a. The order confirmation may be sent to the terminal 3a by e-mail (step 104). The shop server 1 transmits the order-placement data to any of the retailers 4a to 4n (step 105).

The retailer (4a, 4b, 4c or 4n)who has received the order-placement data prepares shipment (step 106) and, transmits pick-up order data including the possible shipping data to the back office when a possible shipping data is fixed. The back office 5 processes pick-up data based on the pick-up order data and order-acceptance data and transmits delivery data including a pick-up date and the retailer (4a, 4b, 4c or 4n) at which the ordered commodity has been for sale to the consolidated delivery company 6 (step 107).

The consolidated delivery service company 6 forms pick-up list based on the transmitted delivery data (step 108) and picks up the commodity at the retailer (4a, 4b, 4c or 4n) (step 109). The retailer (4a, 4b, 4c or 4n) hands over the commodity to the consolidated delivery company 6 after inspection (step 110). Upon completion of picking-up, the consolidated delivery service company 6 transmits pick-up completion data to the back office 5. The back office 5 registers the completion of commodity pick-up based on the pick-up completion data (step 112).

Upon completion of commodity pick-up, the consolidated delivery service company 6 prints outs an invoice (shipping slip) printed with the name of the place of delivery based on the delivery data and wraps the commodity (step 113), delivers the commodity (step 114) and transmits delivery-completion data to the back office 5. Upon receiving the delivery-completion data, the back office 5 registers the completion of shipping (step 115) and notifies the customer 3 of shipping acknowledgement such as the completion of commodity shipment and a scheduled date of delivery, by e-mail (step 116).

When the customer 3 has designated the commodity station 9 as the place of delivery in placing an order, he or she can pick up the commodity at the station 9 any time after the scheduled date of delivery indicated in the shipping acknowledgement mail (step 117).

When the customer 3 has designated another place of delivery, such as his or her home, the consolidated delivery service company 6 delivers the commodity to the customer's home. Then, the customer 3 pays by C.O.D. when he or she has selected such payment when placing an order.

When the customer 3 has designated still another place of delivery, such as his or her friend's home for gift-giving, the consolidated delivery service company 6 delivers the commodity to the friend's home.

Moreover, when the customer 3 has designated the commodity station 9 for delivery, the consolidated delivery service company 6 delivers the commodity to the commodity station 9. When the commodity is delivered (step 118), the station 9 manages it until the customer 3 picks it up (step 119). The station 9 hands over the commodity to the customer 3 when he or she appears. The customer 3 then signs the receipt (step 120). In detail, a clerk at the station 9 checks whether the customer identification data stored in the ID card the customer 3 carries and the customer identification data attached on the commodity match each other, and if so, the clerk hands over the commodity to the customer 3. It is preferable that the customer 3 has been notified of an order number applied to each order to be shown in the order confirmation window or indicated in order confirmation or delivery acknowledgement mail before picking-up the commodity and to check whether the customer's hand-written or print-out order number and that indicated on invoice match each other, on top of ID card verification. Moreover, it is preferable to authenticate the customer 3 using his or her cash card or credit card. When the customer 3 has selected payment at the commodity station 9, he or she pays cash or with cash or debit card based on voucher attached to the commodity or sent separately.

When the commodity station 9 has a point of sales data management system, such as a POS (Point of Sales) system, to collect sales data at certain time or commodity for sales analysis and being able to make an access to the POS terminal or a host computer to check the price of commodity, payment by cash, cash card or debit card is possible at the commodity station 9 based on an order number hand-written or printed out by the customer 3. When the customer 3 prints out an order number, price data may also be printed out simultaneously as a bar code, thus making the payment possible even if no data is being stored in the POS system.

As disclosed above, when the commodity station 9 is designated as the place of delivery, the consolidated delivery service company 6 does not need to deliver the commodity again even if the customer 3 is absent, and the customer 3 can pick up the commodity any time. Thus the present invention is beneficial to both the delivery service company 6 and the customer 3.

The commodity station 9 and the back office 5 may be connected on line to authenticate whether a commodity has been handed over the customer 3 at the station 9, using data on the back office 5 on line. Moreover, notification may be sent to the customer's terminal 3a by e-mail when the commodity has been delivered to the station 9.

The e-commerce with online-shopping system as disclosed above is supported by the support system which will be disclosed in detail with reference to the attached drawings.

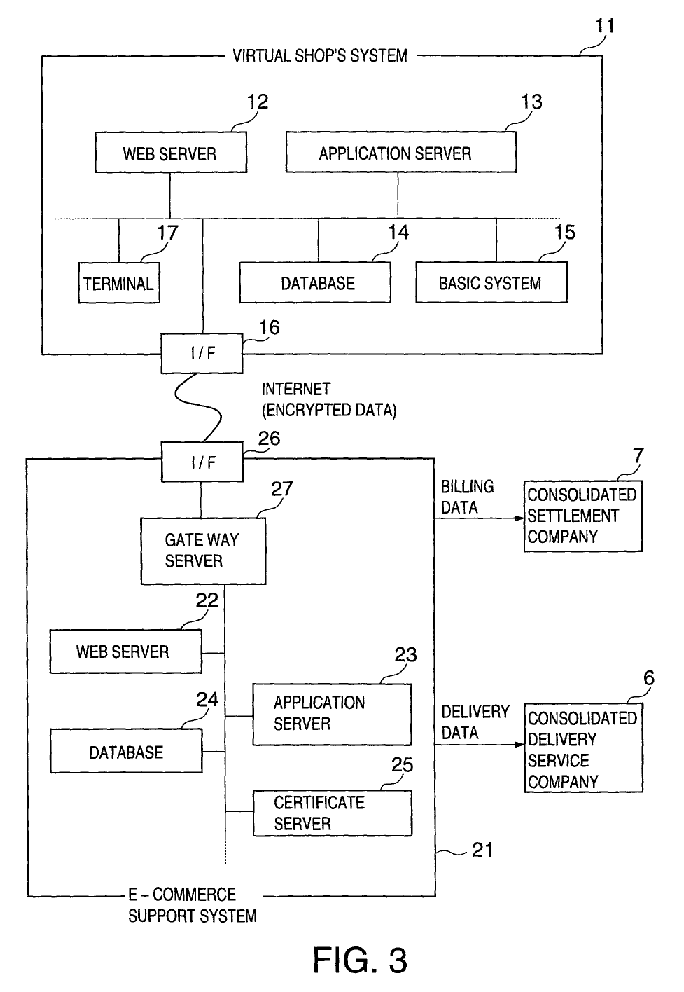

FIG. 3 shows a block diagram of a preferred embodiment of an e-commerce support system according to the present invention.

The retailers 4a to 4n have their own systems 11 that have been established by the retailers themselves or by another such as a system engineering company.

The system 11 may be made up of a terminal 17 only, as disclosed later. The online-shopping system in this case will consist only of an e-commerce support system 21. The system 21 will be shared by the retailers 4a to 4n that have different systems 11, thus each retailer uses only necessary functions of the system 21.

The retailer's system 11 shown in FIG. 3 includes a Web server 12 functioning as both the shop server 1 and the back office 5, a database 14 having a commodity database storing commodities now on sale at the virtual shop and a membership database storing registered membership data necessary for each retailer to run the virtual shop, an application server 13 storing several application programs that will run using the data in the database 14, a basic system 15, and the terminal 17 having a WWW-browser. All components are connected on line and connected to the Internet via an interface (I/F) 16. As already explained, each retailer's system does not necessarily include all components, that is, some retailers have the terminal 17 only or with some of the components.

The e-commerce support system 21 is connected to the Internet via a gateway server 27 and an interface (I/F) 26. The system 21 includes a Web server 22 which will be accessed by the customer's terminal 17 (system 11) for access management to offer different functions to the retailers 4a to 4n, a database 24 having several databases for different functions, an application server 23 storing several application programs that will run using the data in the several databases of the database 24 for several functions for the shop server 1 or the back office 5, such as shop creation function, running management function and delivery management, a certificate server 25 for scanning the membership database in response to access by any of the retailers 4a to 4n and returning the result of customer 3 authentication to the customer 3 to the retailer or performing security management. All components are connected on line.

The database 24 includes a commodity database storing commodities now on sale at each of the virtual shops 2a to 2n, a membership database storing registered data of each member with a table of customer membership numbers managed by the e-commerce support system and the corresponding membership numbers for each of the virtual shops 2a to 2n or each shopping mall 2, an order-acceptance database storing the contents of order, a delivery database for delivery management, a settlement database storing settlement data, and so on.

The system 11 for each retailer and the e-commerce support system 21 transfer encrypted data among each other for security management over the Internet.

The e-commerce support system 21 provides each retailer with any of its functions the retailer does not have, or even the ones it does have due to consideration for differences in performances.

Each retailer can therefore establish the total system 11 using any of the functions of the e-commerce support system 21, which the retailer does not have or the ones it does have but does not use due to differences in performances.

Moreover, each retailer's system 11 may send all data to the e-commerce support system 21, in respect of the type of functions to use. The system 21 then selects required data necessary from both systems in order to operate particular functions by linking each other. Each retailer operates only the terminal 17 (browser) of the system 11 to exercise functions involved in both systems to work.

The e-commerce support system 21 transmits delivery data and billing data to the consolidated delivery service company 6 and the consolidated settlement company 7, respectively. The delivery data and/or billing data may not be transmitted to the corresponding company when a retailer does not use billing data and/or delivery processing functions of the system 21.

The following functions (1) to (4) are the minimum requirement for the systems 11 and 21 to establish the online-shopping system, and functions (5) and (6) are required for securing a sale for the virtual shops:

(1) virtual shop creation function

(2) running management function (back office function)

(3) charge/settlement function

(4) delivery management function

(5) marketing function and

(6) promotion (advertisement) function.

In the present invention, these functions (1) to (6) are put into modules and any of them will be provided to retailers by requesting on the ASP (Active Server Page) system over the Internet, thus providing online-shopping system according to need of retailers.

The functions provided over the Internet in the present invention will be disclosed in detail.

### (1) Shop Creation Function

A shop creation function requires management and maintenance of a Web server, creation of images on a virtual shop (a commodity displaying window, an order window, a gift window, etc.) which will be displayed on a home page to customers over the Internet, and daily home-page up-dating. This function also requires security function to counter hackers, for example. Also required for the membership online-shopping system are a membership database, a membership authentication system, and so on.

The present invention provides a time-based rental server (hardware and software) to offer the e-commerce support system having the shop creation function. Retailers do not need to have their own Web server and virtual shop, and requires no management and maintenance by themselves.

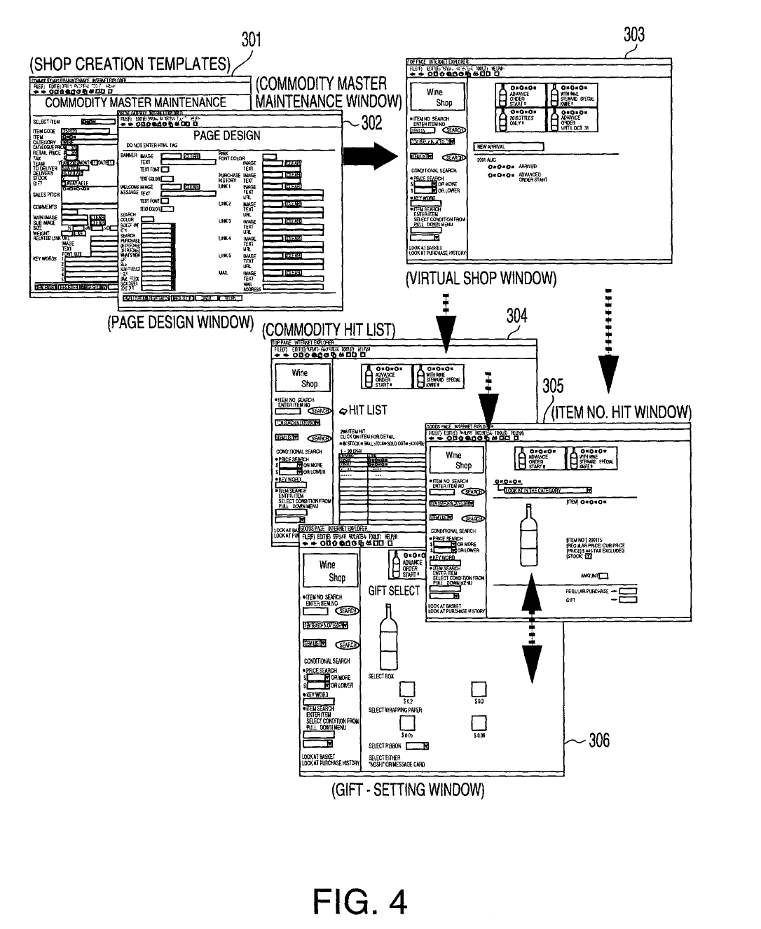

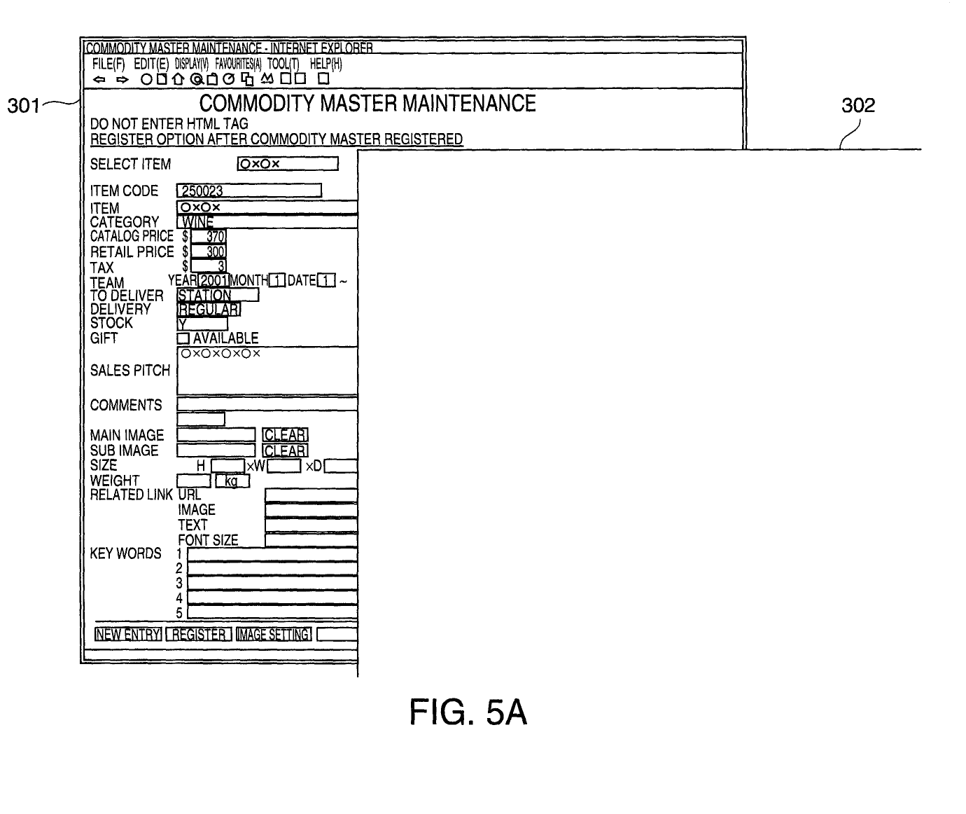

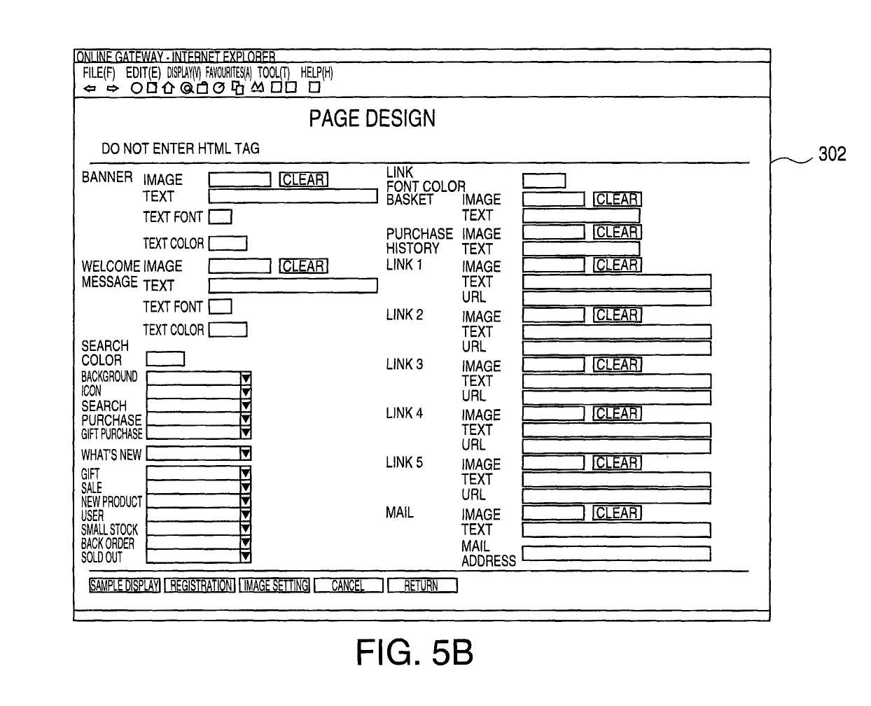

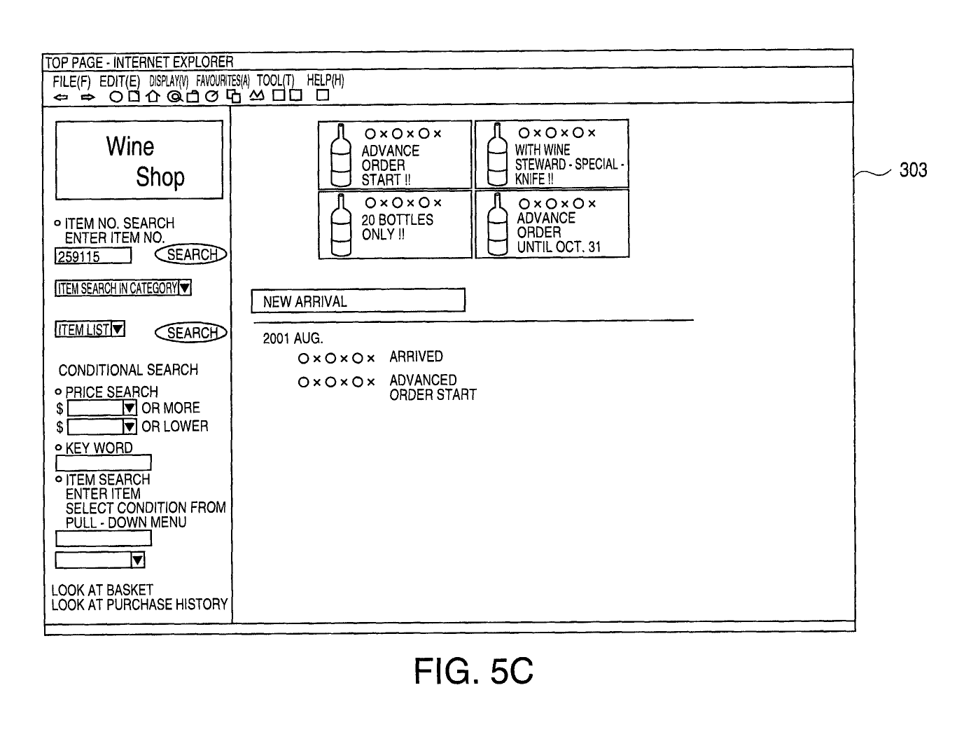

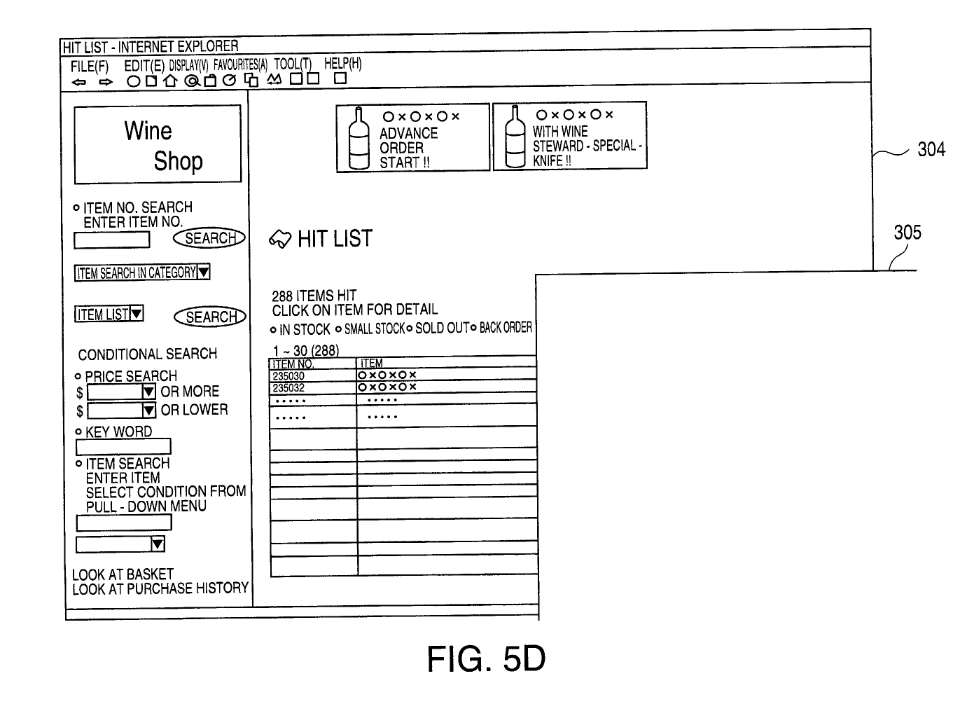

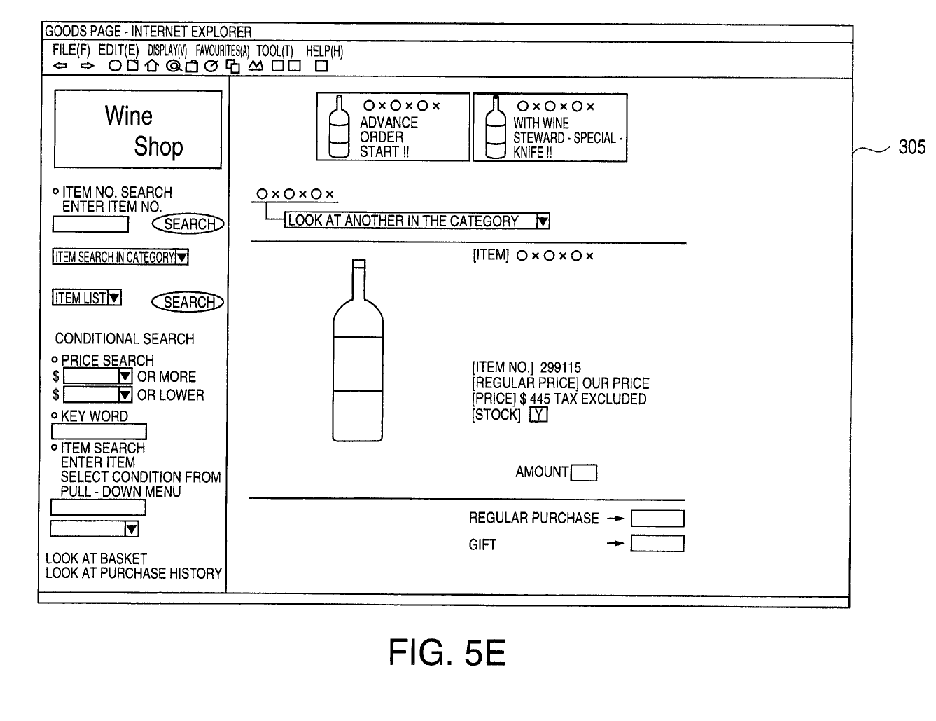

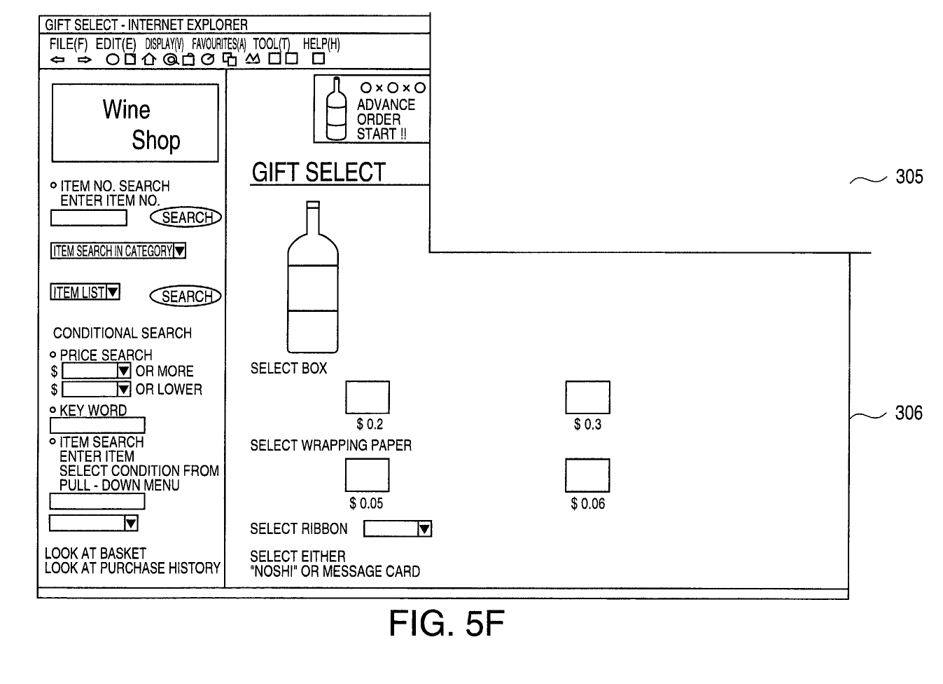

For creation of virtual shops (home pages), the present invention provides shop creation templates 301 to 306 shown in FIGS. 4 and also FIGS. 5A and 5F for retailers who may not know any home-page creation language such as HTML. In detail, retailers make an access to the rental server from the WWW-browser on the terminal 17 over the Internet to operate a shop creation template-GUI (Graphical User Interface) for selecting (editing) a pre-designed page and registering commodities (names, prices, images, shipping charges, stocks, etc.) to be for sale on the page. Thus, retailers can easily and quickly create and update virtual shops by themselves or can ask a company which offers this e-commerce support to do such tasks on behalf of them.

The shop creation templates are also used for creating user windows, such as a commodity search window listing commodities, categories, commodity identification numbers, prices, etc., on which a customer can search commodities, a delivery place-setting window, a gift window on which a customer can select either “noshi” or message if necessary, design of wrapping paper, color and type of ribbon, etc. The term “noshi” means a slip on a wrapping paper of a gift expressing best wishes for someone's birthday, for example, according to Japanese custom.

The shop windows created as above are stored on the server that offers the e-commerce support system with commodity information (designed page and commodity master registration).

The server for offering the e-commerce support system is accessible only with ID and a password entry assigned for each user (retailer) through SSI (cipher) or retailer authenticating system.

The shop creation templates can be used via a maintenance window provided for each user (retailer), thus any customer or retailer who have been disapproved as a member of the online-shopping system would not be able to use it.

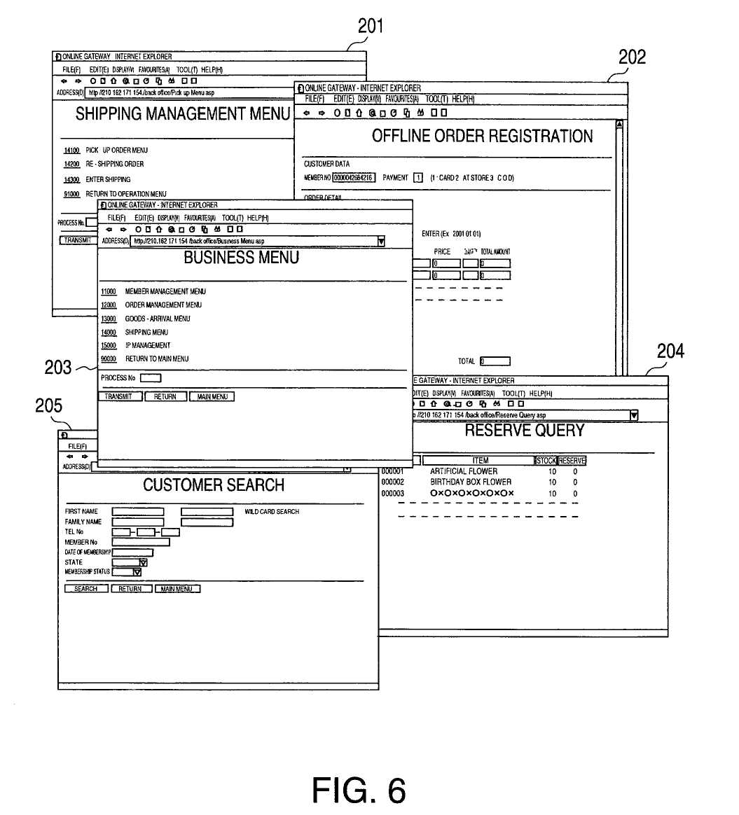

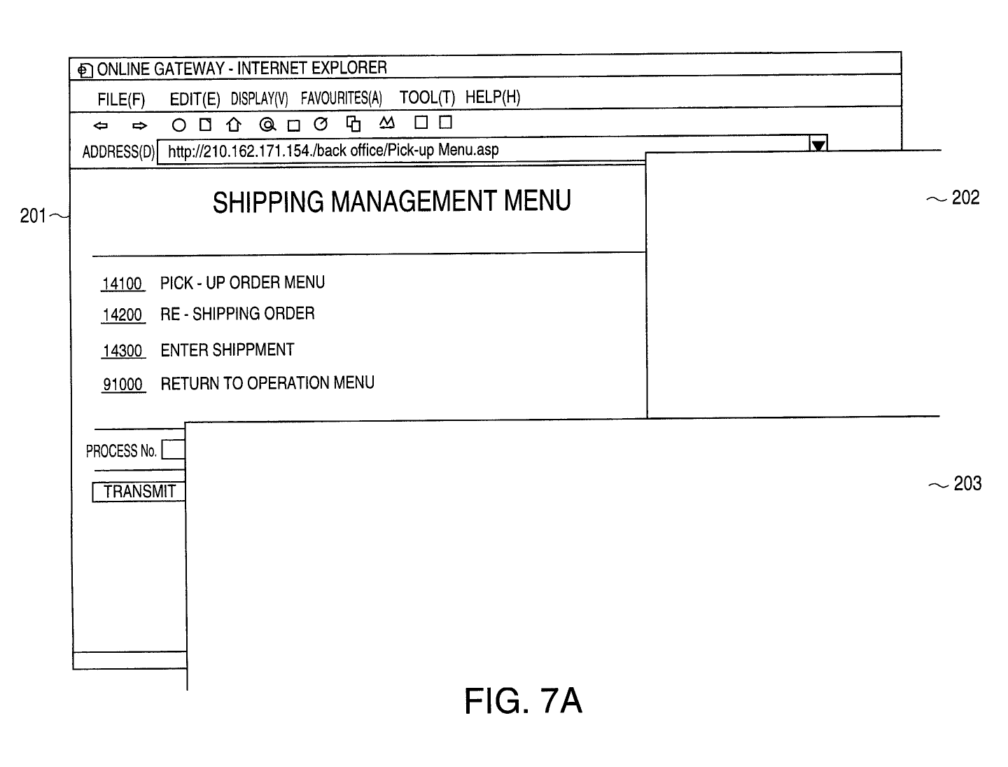

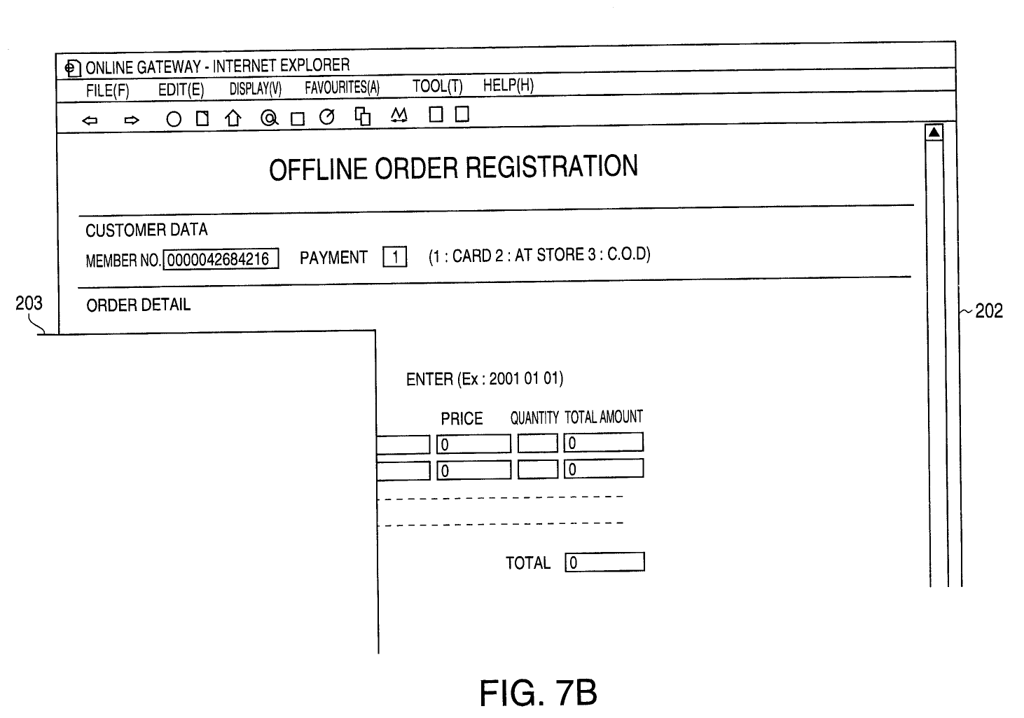

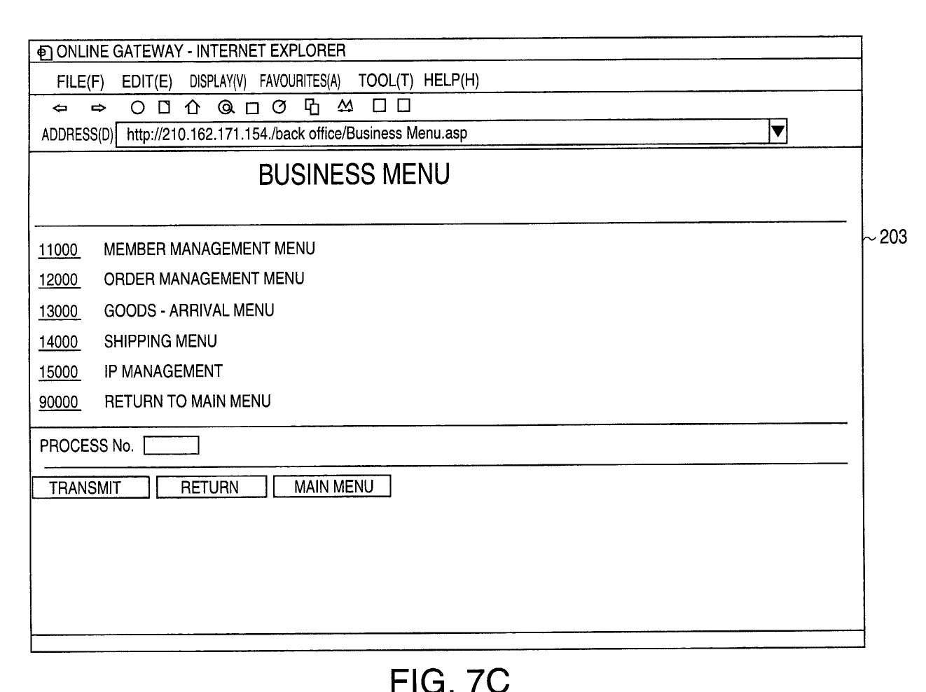

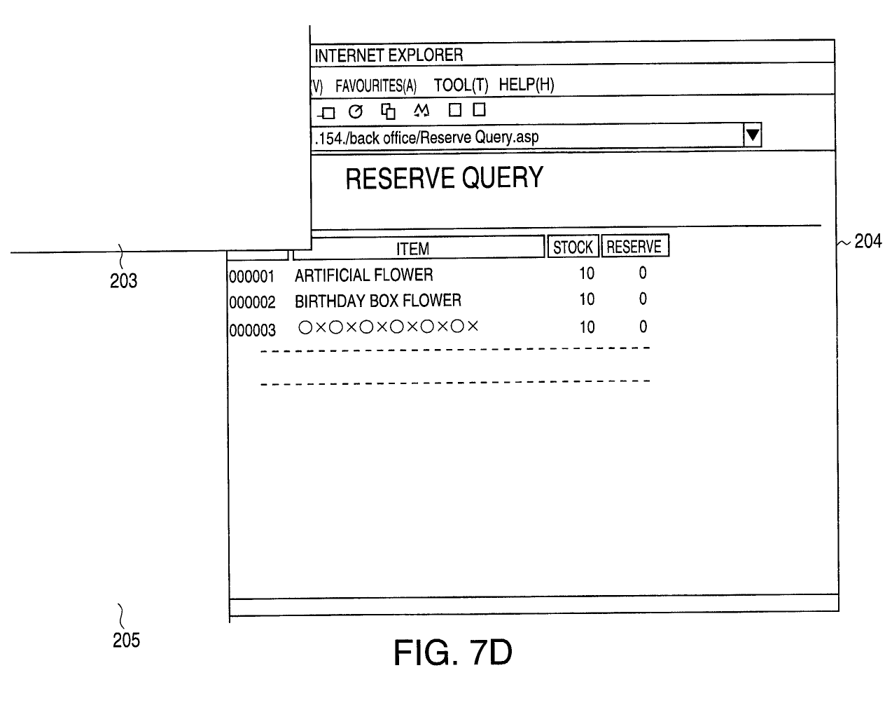

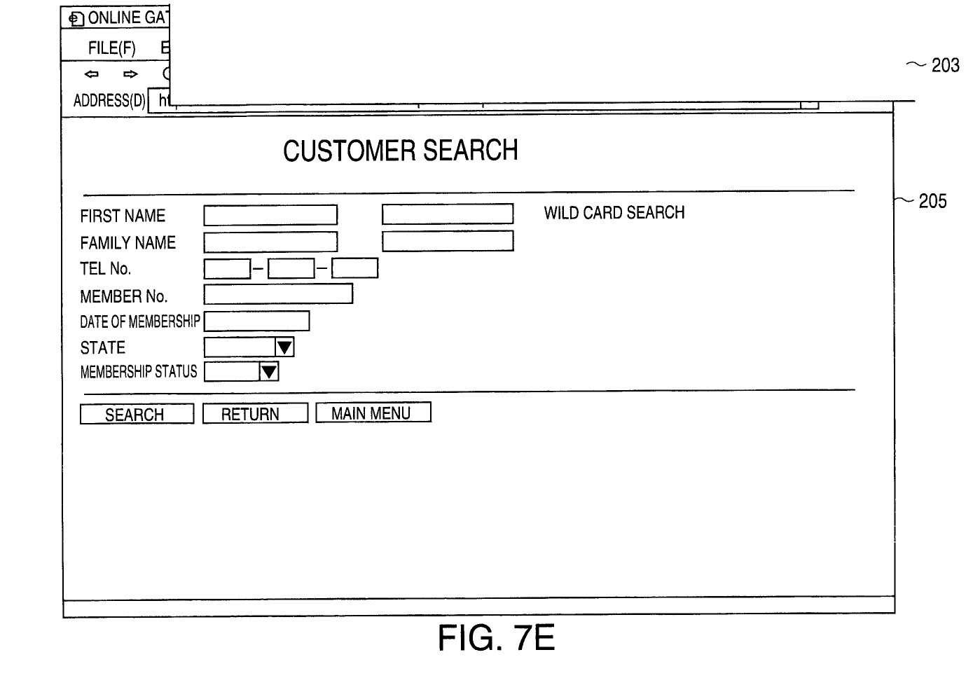

### (2) Running Management Function (back office function 203 in FIGS. 6 and 7C)

A running management menu is provided to each retailer through browser over the Internet. Any customer or retailer who have been disapproved as a member of the online-shopping system cannot make an access to this menu, like the shop creation function disclosed above.

The running management menu offers several functions (operated via GUI), such as those listed as follows:

(a) order management (order inquiry) function (202, 204 in FIG. 6 and FIGS. 7A and 7B, respectively) for recording order details, changing or canceling an order, outputting order list, managing stocks, etc;

(b) shipping management function (201 in FIGS. 6 and 7A) for managing inquiry on commodity pick-up to delivery, tracing and returned commodity data;

(c) sales management function for recording sales, inquiry on today's sales or sales for a certain period and outputting these values;

(d) paying-in management function for checking the account to determine whether or not there has been a payment to sales or to trace payment; and

(e) customer management function (205 in FIGS. 6 and 7E) for total management of retailers' customer data with membership identification numbers assigned to members registered on each retailer's database, the numbers being different from identification numbers assigned by each retailer, to offer only data protected from invasion of privacy for inquiry on member customers.

In the customer management function (e), there is data to which each retailer is impossible or hard to make an access to, such as, data on customers listed on a black list on another retailer or prohibited to use a cash card. The e-commerce support system 21 according to the present invention, however, allows the retailers 4a to 4n to use several functions, thus the system 21 being able to collect data, to which each retailer is impossible or hard to make an access to, for storing customer data with membership identification numbers registration, the identification number being peculiar to the system 21. Therefore, each retailer can authenticate customers, even if the retailer does not have its own customer credibility database.

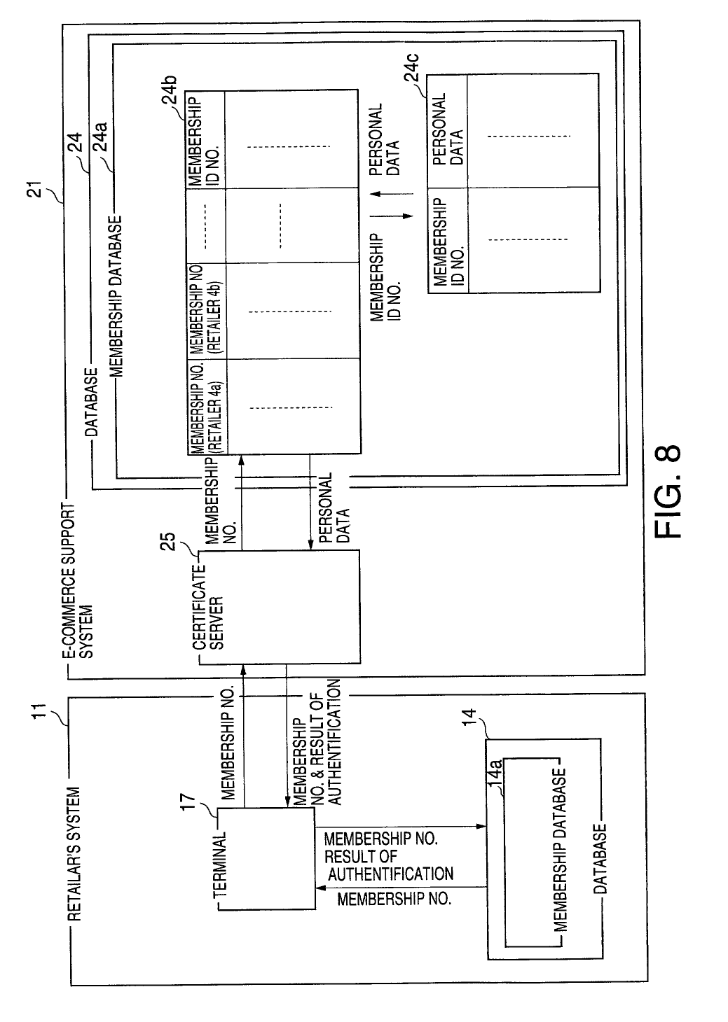

Moreover, the e-commerce support system is provided with a table 24b in a membership database 24a of the data base 24 as shown in FIG. 8, which stores the membership numbers assigned by each retailer and the corresponding membership identification numbers assigned by the system 21 for authenticating customers while protecting them from violation of privacy.

This table 24b is useful for retailers who have their own customer management system with membership numbers assigned for its customers. For example, when the retailer 4a has such customer management system, it transmits a membership number of the customer 3 for credibility inquiry from a membership database 14a in the database 14 of the system 11 to the certificate server 25 of the e-commerce support system 21.

The certificate server 25 makes an access to the membership database 24a of the database 24 to scan the table 24b to retrieve a membership identification number peculiar to the e-commerce support system 21, which corresponds to the membership number of the customer 3 in the membership database 14a of the system 11. Further access is made to a personal data 24c using the retrieved membership identification number to check if the customer 3 is credible as a customer.

The certificate server 25 transmits only the result of credibility with the membership number to the terminal 17 of the retailer 4a. The membership number transmitted to the terminal 17 is the number that has been assigned to the customer 3 in the retailer 4a's customer management system. Accordingly, customer authentication is made possible without disclosing other data of the customer 3 to the retailer 4a, such as customer's data on other retailers and the number of times accessed.

Each of the functions (a) to (e) is put into a module so that the e-commerce support system offers necessary functions only to each retailer.

(3) Charge/Settlement Function

Generally, retailers use postal transfer or payment on C.O.D. offered by a delivery service company. On the contrary, instead of general postal transfer, the e-commerce support system according to the present invention provides several settlement functions, such as, using credit cards, debit cards, payment at commodity station (convenience store) and payment on C.O.D. with high security.

(4) Delivery Management Function

In general, a retailer orders a delivery service company to pick up a commodity and deliver it to a place designated by a customer.

On the contrary, in this invention, when a customer places an order, stocks are automatically checked, and when an ordered commodity is in stock, a delivery service company picks up and delivers it to a place designated by a customer. An automatic delivery check output is also possible.

Moreover, customers can designate convenience stores for keeping ordered and delivered commodities for certain days under a contract between convenience stores and a company using the e-commerce support system according to the present invention, such a contract being difficult for each retailer to have with convenience stores.

### (5) Marketing Function

Marketing activities are very effective for improving quality of commodities to be sold at virtual shops. The e-commerce support system according to the present invention offers a market researching function to conduct survey to customers, analysis of accessing, sales, ratio of settlement methods (cash card, debit card, payment on C.O.D., etc.), place of delivery (customer's home/office, convenience store, another person's home for gift-giving, etc), and various data for such analysis.

For a membership shopping mall, the e-commerce support system according to the present invention offers customer data, such as, residential area, sex and age, together with analysis of customer's character and preference.

### (6) Promotional (Advertisement) Function

Electronic commerce over the Internet requires sales promotion for potential customers focusing on specific fields according to their preference. Moreover, registration on search sites which potential customers often visit or taking a banner advertisement in popular sites are required to get new customers. It is, however, hard for retailers to conduct such advertising.

The e-commerce support system according to the present invention offers several advertisement supporting functions, such as, an automatic customer mailing list compiling function, a direct-mail delivery function for advertising new products, an over-the Internet-advertisement supporting function, and promotional activity function for each customer in accordance with analysis of customers.

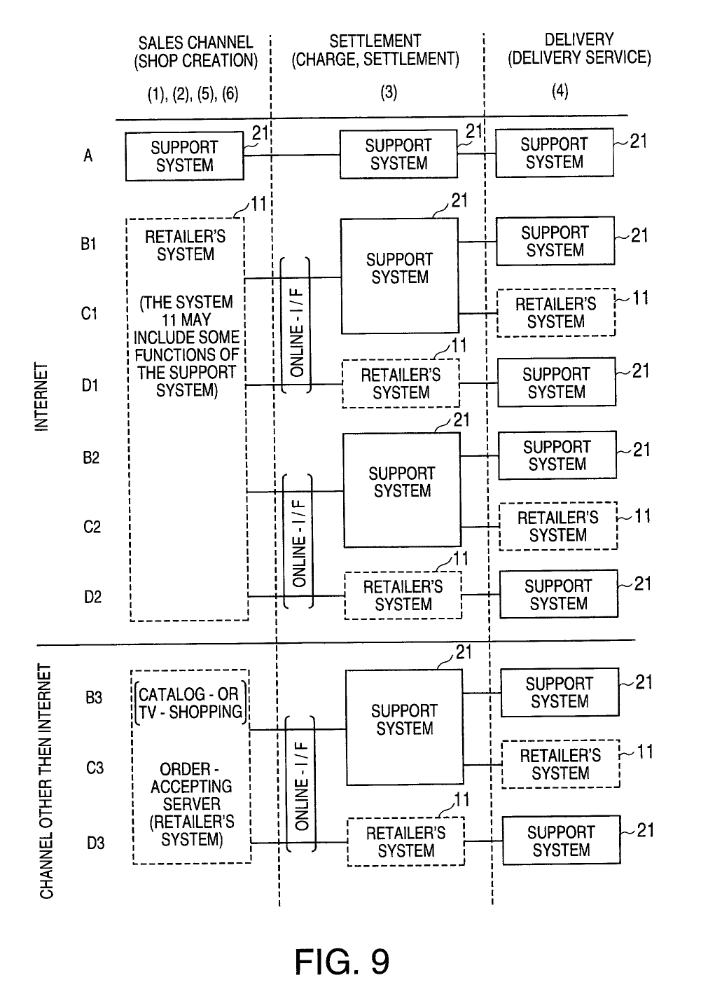

Retailers require different types of functions for business operations offered by the e-commerce support system according to need. To meet such requirements, the e-commerce support system according to the present invention is established so that the function disclosed above are separately selected, as illustrated in FIG. 9 for retailers to select and combine functions according to need to establish their own e-commerce systems.

Disclosed with reference to FIG. 9 are some examples of combination of functions.

Electronic commerce are classified, for example, into types A, B1 to B3, C1 to C3 and D1 to D3, as shown in FIG. 9, in accordance with functions of sales channel, settlement and delivery operated in the retailers system 11 or the e-commerce support system 21.

The e-commerce (types A, B1, C1, D1, B2, C2 and D2) are mainly performed for online-shopping over the Internet. On the other hand, the e-commerce (types B3, C3 and D3) are performed for mail-order, TV-shopping on the phone or via FAX, not over the Internet.

The sale channel function includes the shop creating function (1) and the running management function (back office function) (2) already disclosed. The settlement function includes the charge and settlement functions (3). And, the delivery function includes the delivery function (4). Moreover, although not shown, the marketing function (5) and the promotional (advertisement) function (6) can be offered by the e-commerce support system 21 according to retailers'need.

The types A, B1 to B3, C1 to C3 and D1 to D3 in FIG. 9 are defined as follows:

Type A: All functions in sales channel, settlement and delivery are operated in the e-commerce support system 21. The retailers 4a to 4n act just as a retailer and rely on the support system 21 for all operations in the online-shopping system to establish and running the shopping system.

Types B1, C1, D1, B2, C2 and D2: All or several functions in sales channel are operated in the retailer's system 11.

Type B1, C1, D1, B2 and C2: All functions in settlement are operated in the e-commerce support system 11.

Types B1, D1, B2 and D2: All functions in delivery are operated in the e-commerce support system 11.

Types B3, C3 and D3: e-commerce on catalog, commercial, etc., other than over the Internet as for sales channel. The present invention is also applicable in this case. In detail, when there is a placement of an order on telephone or via FAX, a retailer registers and manages the order data in an order-accepting server. The server transmits charge data to a settlement system of e-commerce support system 21 (types B3, C3) or the retailer's system 11 (type D3) via off- or on-line. The order-accepting server further transmits delivery data to a delivery system of the e-commerce support system 21 (types B3, D3) or the retailer's system 11 (type C3).

As disclosed, the present invention is applicable not only for online-shopping but also shopping on telephone or via FAX.

Either the shop creation function (1) or the running management (back office) function (2) can be offered by the e-commerce support system 21 to retailers when they operate functions in sales channel at their system 11 (types B1, C1, D1, B2, C2 and D2).

The Web server 12 of the retailer's system 11 has been provided with several functions for sales channel. Thus, a retailer can select either the function (1) or (2) from the Web server 22 of the e-commerce support system to establish the entire system for sales channel. The e-commerce system is then operated while data are communicated between the Web servers 12 and 22.

Accordingly, retailers can establish the e-commerce system by not preparing all functions required for sales channel at the retailers'system 11 but borrowing some necessary functions from the e-commerce support system 21.

As disclosed above, the e-commerce support system according to the present invention is provided with rental modules for several e-commerce functions. Thus, retailers can easily establish a high-performance e-commerce system while constructing some part of it by themselves as they like and borrowing rental modules for the functions which are difficult for retailers to construct.

Moreover, the e-commerce support system according to the present invention is provided with rental modules for several e-commerce functions, which can be shared by several retailers without buying a server for such functions, thus the present invention achieves a high cost-performance e-commerce support system.

What is claimed is:

1. An electronic (e-) commerce support system comprising:
a Web server to which each retailer makes an access via a terminal of each retailer over a network, thus performing access management for each retailer;
a database storing data for each of functions required for e-commerce; and
an application server to establish each of the functions by using the stored data, necessary functions among the functions required for e-commerce being offered to each retailer and available through the terminal of each retailer over the network.

2. The electronic commerce support system according to claim 1, wherein the functions include at least a shop creation function, a running management function, a charge and settlement function and a delivery function.

3. The electronic commerce support system according to claim 1, wherein each function is put into a module.

4. The electronic commerce support system according to claim 1 further comprising:
a table storing membership numbers assigned to customers by each retailer and membership identification numbers assigned to customers by the electronic commerce supporting system irrespective of each retailer but corresponding to the membership numbers;
a customer database storing personal data on the customers for each of the membership identification numbers; and
a certificate server to authenticate a customer using the table and the customer database in response to a membership number sent by a retailer via the terminal thereof, a result of authentication being sent only to the terminal of the retailer which has made an access to the certificate server for customer authentication.
